(19) United States
(12) Patent Application Publication
(10) Pub. No.: US 2024/0420268 A1
(43) Pub. Date: Dec. 19, 2024

(54) CAR DEALERSHIP SYSTEM AND METHOD

(71) Applicant: TRUSTY CARS LTD., Singapore (SG)

(72) Inventor: Mingtai CHEN, Singapore (SG)

(73) Assignee: TRUSTY CARS LTD., Singapore (SG)

(21) Appl. No.: 18/700,832

(22) PCT Filed: Oct. 14, 2021
(86) PCT No.: PCT/SG2021/050622

§ 371 Date: Apr. 12, 2024

(51) Int. Cl. G06Q 50/40; G06Q 10/087; G06Q 30/0601; G07C 9/00

(52) U.S. Cl. CPC G06Q 50/40; G06Q 10/087; G06Q 30/0625; G07C 9/00571; G07C 2009/00984

(57) ABSTRACT

A car dealership system is disclosed. The system includes a database configurable to maintain a record for each of a number of cars for sale. The cars are located at different geographical sites and each record includes a geographic location of a corresponding one of the cars. The system further includes a server. The server is operable to retrieve one or more records from the database and provide a user device with the one or more retrieved records. The server is further operable to receive information from the user device indicating interest in viewing one or more cars corresponding to the one or more retrieved records and send an instruction remotely to an unlocking device located within or in the proximity of the one or more cars to automatically unlock the one or more cars. A method of dealing in cars is also disclosed.

### TECHNICAL FIELD

This invention relates to a car dealership system and method. More particularly, this invention relates to a car dealership system and method for used cars.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

A typical used car dealership showroom is located at one single location that needs to provide ample parking spaces for cars that are for sale. Salespersons are also typically present at the location to attend to customers, to provide them with information of the cars, to lock and unlock cars for the customers to view and also accompany them on test drives. Being centrally located at one location may be inconvenient for customers, especially those who live a long distance away from the showroom. With the large space and manpower required at the showroom, the overheads of the car dealership may thus also be high.

There is therefore a need for a car dealership system which addresses, at least in part, one or more of the forgoing problems.

### SUMMARY

According to an aspect of the present disclosure, there is provided a car dealership system. The system includes a database configurable to maintain a record for each of a number of cars for sale. The cars are located at different geographical sites and each record includes a geographic location of a corresponding one of the cars. The system further includes a server that is operable to retrieve one or more records from the database; provide a user device with the one or more retrieved records; receive information from the user device indicating interest in viewing one or more cars corresponding to the one or more retrieved records; and send an instruction remotely to an unlocking device located within or in the proximity of the one or more cars to automatically unlock the one or more cars.

In some embodiments of the system, the user device includes a mobile device. And the server is further operable to receive a location of the mobile device. In such a case, retrieving one or more records from the database includes retrieving one or more records from the database based on the location of the mobile device.

In some embodiments of the system, retrieving one or more records from the database based on the location of the mobile device includes retrieving one or more records from the database having a geographic location closest to the location of the mobile device.

In some embodiments of the system, the unlocking device is located within the one or more cars and configured to actuate an unlock key of a key fob of the one or more cars.

In some embodiments of the system, the instruction to automatically unlock the one or more cars includes a short messaging service (SMS) message sent to the unlocking device.

In some embodiments of the system, receiving information from the user device includes receiving information obtainable from a label attached to the car using the user device.

In some embodiments of the system, the label includes a QR code.

In some embodiments of the system, the instruction unlocks all cars at the same geographic location as the at least one car.

In some embodiments of the system, the server is further operable to receive information of a user using the user device after receiving information from the user device of one or more cars corresponding to the one or more retrieved records.

In some embodiments of the system, the server is further operable to send to the user device the user's queue position before the user's turn to access the at least one car after receiving the user's information.

In some embodiments of the system, the server is further operable to receive from the user device information to unlock the one or more cars prior to the server sending the instruction to the unlocking device.

In some embodiments of the system, the server is further operable to send to the user device information relating to an amount of time left for the user to view the at least one car.

In some embodiments of the system, the server is further operable to send to the user device information indicating time for the user to view the one or more cars is up and that the user should lock the one or more cars.

In some embodiments of the system, the server is further operable to send an instruction to a locking device to automatically lock the one or more cars.

In some embodiments of the system, the system further includes the user device.

According to another aspect of the present disclosure, there is provided a method of dealing in cars. The method includes a dealer locating cars at different geographic locations and the dealer maintaining a database having a record for each of the cars. The record includes a geographic location of the car. The method further includes the dealer retrieving one or more records from the database; the dealer providing a potential buyer with the one or more retrieved records; the dealer receiving from the potential buyer information indicating interest in viewing one or more cars corresponding to the one or more retrieved records; and the dealer sending an instruction remotely to an unlocking device located either within or in the proximity of the one or more cars to automatically unlock the one or more cars.

In some embodiments of the method, the method further includes the potential buyer providing the dealer with a location of the potential buyer, and wherein the dealer retrieving at least one record from the database includes the dealer retrieving one or more records from the database based on the location of the potential buyer.

In some embodiments of the method, the dealer retrieving one or more records from the database based on the location of the potential buyer includes the dealer retrieving one or more records from the database having a geographic location closest to the location of the potential buyer.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a block diagram of a car dealership system according to an embodiment of the invention, the system including a mobile device;

FIG. 2 is a flow diagram showing a method of operating the system in FIG. 1 according to another embodiment of the invention;

FIG. 3 is a catalog screen that is displayed on the mobile device in FIG. 1, the catalog screen including a “View Other Locations” button;

FIG. 4 is a location screen that is displayed on the mobile device in FIG. 1 when the “View Other Locations” button in FIG. 3 is selected, the location screen including two or more locations;

FIG. 5 is another catalog screen that is displayed on the mobile device in FIG. 1 when one of the two or more locations in FIG. 4 is selected;

FIG. 6 is a screen on the mobile device in FIG. 1 when it is used to scan a QR code located on a car at a selected location;

FIG. 7 is a profile screen that is displayed on the mobile device in FIG. 1;

FIGS. 8-11 are queue screens that are displayed on the mobile device in FIG. 1 showing a potential buyer's position in a queue for viewing one or more cars at the selected location;

FIGS. 12 and 13 are unlock-car screens that are displayed on the mobile device in FIG. 1 showing status of unlocking the one or more cars when it is the turn of the potential buyer to view the one or more cars;

FIG. 14-17 are time left screens that are displayed on the mobile device in FIG. 1 showing the amount of time left the potential buyer has for viewing the one or more cars; and

FIG. 18 is a cars viewed screen that is displayed on the mobile device in FIG. 1 when time for viewing the one or more cars is up.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

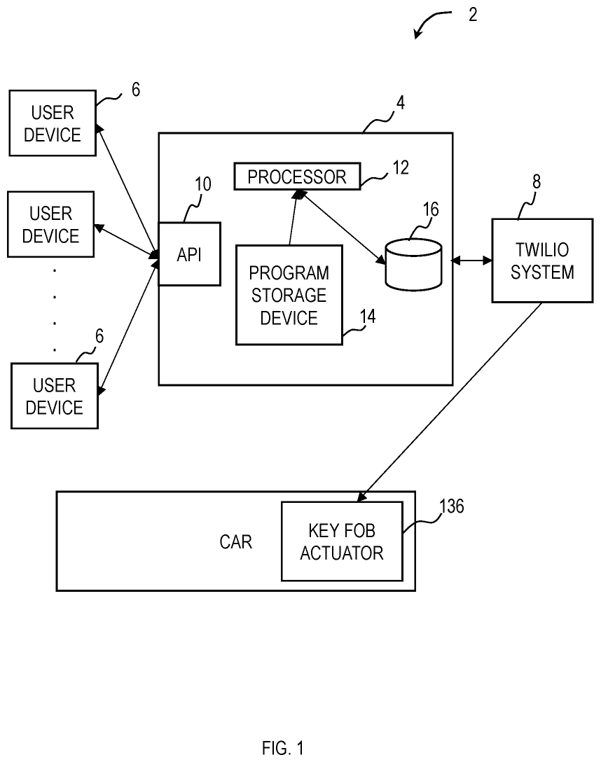

As shown in the drawings for purposes of illustration, the invention may be embodied in a novel car dealership system. Referring to FIG. 1, a car dealership system embodying the invention generally includes a database configurable to maintain a record for each of a number of cars for sale. The cars are located at different geographical sites and each record includes a geographic location of a corresponding one of the cars. The system further includes a server. The server is operable to retrieve one or more records from the database and provide a user device with the one or more retrieved records. The server is further operable to receive information from the user device indicating interest in viewing one or more cars corresponding to the one or more retrieved records and send an instruction remotely to an unlocking device located within or in the proximity of the one or more cars to automatically unlock the one or more cars.

Specifically, FIG. 1 shows a car dealership system 2 according to an embodiment of the invention. The system 2 includes a server 4, multiple user devices 6 and a Twilio system 8 (Twilio is a trademark of Twilio Inc.). The users of the system 2 include a car dealership who is the administrator of the server 4, and potential car buyers. The server 4 is data communicatively coupled, via a wide area network such as the Internet (not shown), to the user devices 6 and the Twilio system 8. The server 4 may typically be built around a single centralized server 4 that handles all processing. Alternatively, the server 4 may also be a decentralized server. The system 2 is based upon a client-server architecture. The user devices 6 function as clients. The clients request content or service from the server 4. The clients therefore initiate communication sessions with the server 4, which await incoming requests. The clients and the server 4 exchange messages in a request-response messaging pattern. A client sends a request, and the server 4 returns a response. The language and rules of communication between the clients and the server 4 are defined in any suitable communication protocol known to those skilled in the art. To formalize the data exchange even further, the server 4 may implement an application programming interface (API) gateway 10 which is an abstraction layer for accessing a service on the server 4. Similarly, the server 4 functioning as a client in some instances accesses contents/services on the Twilio system 8.

The server 4 includes at least one processor/processing unit 12 and a program storage device 14 readable by the processing unit 12 that tangibly embodies a program of instructions, executable by the processing unit 12 to provide services of the server 4. The program of instructions includes the application programming interface (API) gateway 10. The server 4 further includes a database 16. The user devices 6 may be any computing device, including but not limited to, a personal computer, a laptop, a notebook, a tablet, a mobile device such as a smart phone, etc. These user devices 6 interact with the server 4 to access services provided by the server 4 via the API gateway 10 of the server 4. The accessing of services involves transfer of data between the user devices 6 and the server 4.

Each user device 6 may include at least one processing unit/processor and a form of memory (both not shown). Various means are available on these user devices 6 for accessing services provided by the server 4. One of these means is via a mobile application (App for short, not shown) running on the user devices 6, especially smart phones. The App is a software application that is downloaded and installed on the smart phones 6. The App pulls content and data from the server 4 through the Internet. Other means via which the user devices 6 may access services provided by the server 4 is a web portal or a mobile portal (both not shown) supported by the server 4. These portals are private locations on the Internet, accessible with unique URLs (web addresses) and unique usernames and passwords. A web portal is typically accessible via a web browser on a user device 6 to provide a page on the worldwide web or another access point for the user device 6 to engage with the server 4. However, the services may also be further accessible via websites and mobile websites (both not shown). Suitable graphical user interfaces (GUIs) are provided on the user devices 6 for each of these means to enable the users to access the services of the server 4.

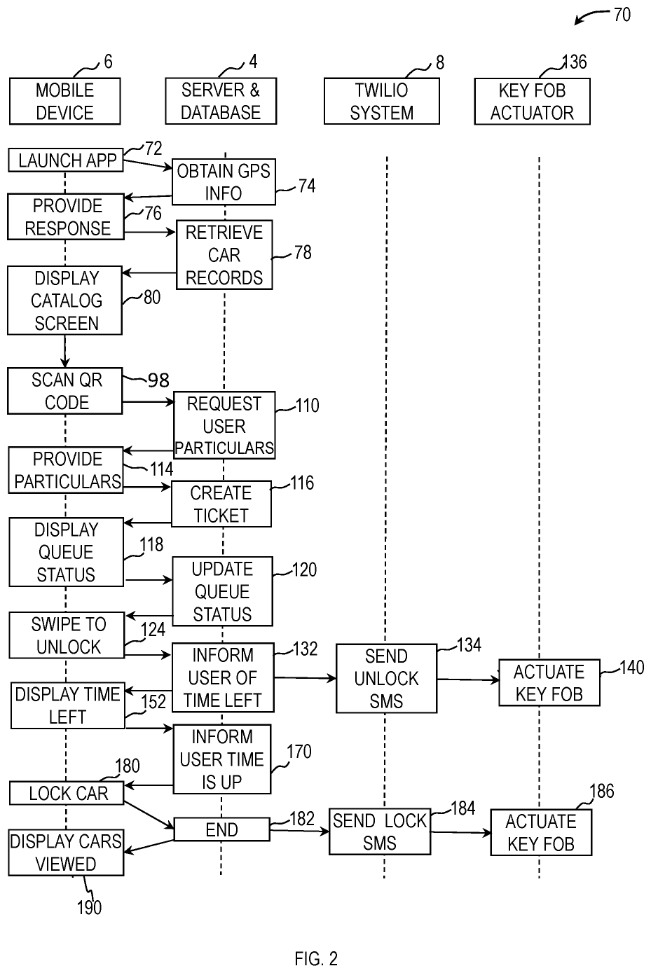

A method of dealing in used cars as implemented in the system 2 according to an embodiment is next described with the aid of FIG. 2. The method 70 starts in a LAUNCH APP step 72, wherein a potential buyer runs the App on his or her mobile device 6. The mobile device 6 establishes a connection with the server 4, and sends information such as the name and phone number of the potential buyer to the server 4. The method 70 next proceeds to an OBTAIN GPS INFO step 74 at the server 4, wherein the server 4 requests the mobile device 6 to provide its GPS location information. The method 70 next proceeds to a PROVIDE RESPONSE step 76 at the mobile device 6, wherein the mobile device 6 receives an input response from the potential buyer. In this PROVIDE RESPONSE step 76, if the input response from the potential buyer is not to provide the server 4 with the location information, the mobile device 6 will send a disapproval message to the server 4. If however, the input response from the potential buyer is to send the location information to the server 4, the mobile device 6 will obtain its GPS location information and send that location information to the server 4.

The method 70 next proceeds to a RETRIEVE CAR RECORDS step 78 in the server 4, wherein the server 4 retrieves records from the database 16 based on the information received from the mobile device 6. If no GPS location information is provided by the mobile device 6, i.e., a disapproval message is received, the server 4 would simply provide the mobile device 6 with a list of showroom locations sorted in any suitable order, for example in an alphabetical order. Alternatively, the server 4 can send information of cars available in any showroom to the mobile device 6. The showroom may be randomly selected or a first showroom in a list of alphabetically sorted showrooms. If, however, the mobile device 6 provided the server 4 with the GPS location information of the mobile device 6 in the PROVIDE RESPONSE step 76, the server 4 will determine if there is any showroom within a predetermined distance, for example 10 km, from the GPS location of the mobile device 6. If it is determined that there is one or more showrooms within the predetermined distance from the location of the mobile device 6, the server 4 will send information of cars located in a showroom closest to the location of the mobile device 6. In other words, the records retrieved from the database 16 is based on the location of the mobile device 6. The information sent to the mobile device 6 includes information related to cars available at that showroom.

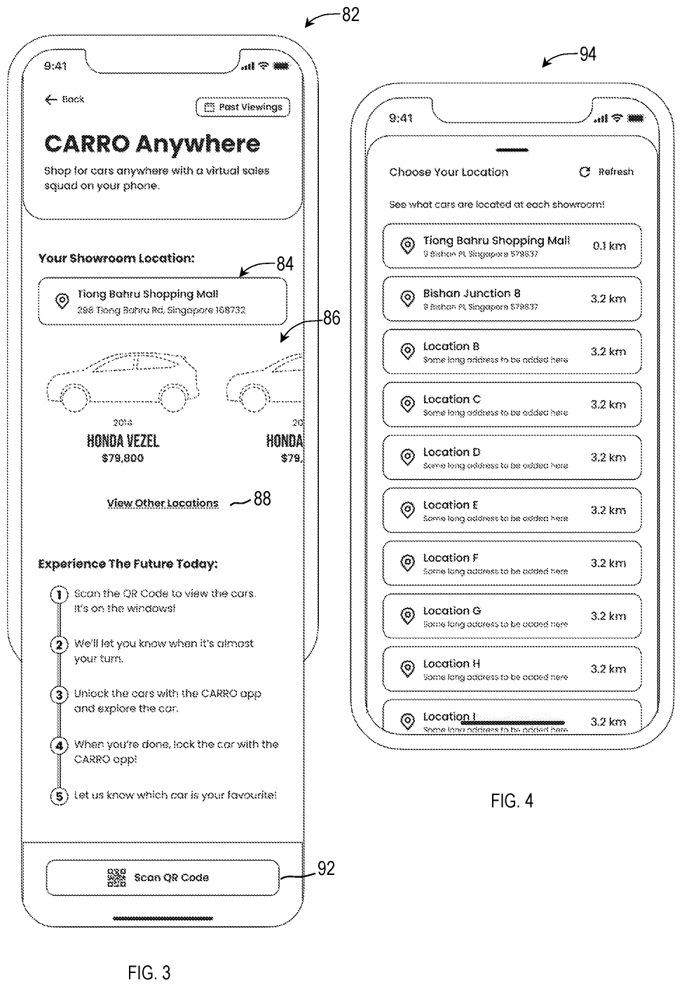

The method 70 next proceeds to a DISPLAY CATALOG SCREEN step 80 in the mobile device 6, wherein the mobile device 6 uses the information received from the server 4 to display a catalog screen 82 of available cars as shown in FIG. 3. This catalog screen 82 includes the location 84 of the showroom, a list 86 of cars available at the showroom and a button 88 for selection of showrooms at other locations. The list 86 of cars are displayed in a row with a horizontal scroll. For example, FIG. 3 shows a first car that is completely shown and a second car for which only half of the car is shown. This is to make navigation intuitive so that the potential buyer will readily appreciate that there are more than one car available at the showroom and will scroll in the horizontal direction to see the other cars that are available. The information of each car, such as but not limited to, the visual appearance, current price, etc. is provided. The catalog screen 82 also includes guidance information 90 relating to what the potential buyer can do and expect. The catalog screen 82 further includes a call-to-action “Scan QR Code” button 92 to invite the potential buyer to scan a QR code on a car to indicate his or her interest in viewing the cars at the showroom. The QR code is a unique code associated with the showroom. Other forms of providing the server with the unique code are also possible. The unique code may be in the form of a bar-code, an image of a car's license plate number or simply entry of the car license's plate number into the mobile device 6, etc.

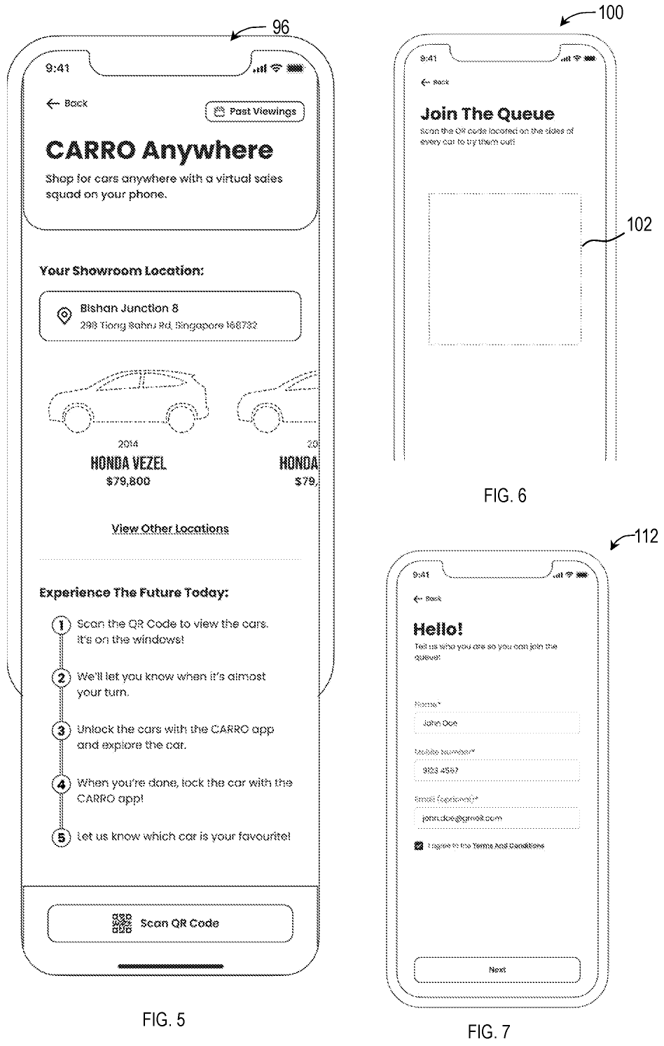

In the DISPLAY CATALOG SCREEN step 80, if the potential buyer selects the “View Other Locations” button 88 by tapping on that button 88 on the screen, the mobile device 6 will communicate with the server 4 to obtain a list of showrooms and display them in a locations screen 94 as shown in FIG. 4. This location screen 94 includes a list of showrooms at all the different locations. The showroom closest to the mobile device 6 will be displayed at the top of the locations screen 94 as shown in FIG. 4. All other showroom locations may then be displayed according to their distance from the mobile device 6, in alphabetical order, according to the number of cars available at each showroom, etc. The last location name is partially shown on the locations screen 94 so that the potential buyer knows that what is shown may not be a complete list of location names and is more likely to scroll vertically to view the remaining location names that are not shown. Each location name is selectable so that another catalog screen, similar to the first catalog screen 82 shown in FIG. 3, can be displayed. If for example the potential buyer selects the location name “Bishan Junction 8”, a second catalog screen 96 as shown in FIG. 5 will be displayed on the mobile device 6. In each catalog screen 82, 96, the potential buyer may select any displayed car to view further details of the car. These details include general details, details of the car, financial details, inspection summary details, and installment details. The general details include one or more of the price of the car, details of Carro's warranty service “CARRO ASSURE PLUS”, the car registration date, the remaining duration of a Certificate of Entitlement (COE), the number of previous owners, the current mileage, the yearly depreciation rate, and the applicable road tax. The car details include one or more of the fuel type, the type of transmission, the engine capacity, the horse power (if applicable), and the number of seats. The financial details include one or more of the COE amount, the Open Market Value, the scrap value, the applicable Additional Registration Fee, the down payment value, and the paper value. The inspection summary details include one or more of the condition of the air conditioning system, the existence of major accidents, the condition of the suspension, on board diagnostics, engine and transmission, tires and brakes, and any visual imperfections. And the installment details include one or more of the estimated monthly instalment rate based on car price, the loan amount, the down payment, the interest rate, and the loan tenure.

When the potential buyer tabs on the “Scan QR Code” button in the catalog screen 82, the method 70 next proceeds to a SCAN QR CODE step 98 in the mobile device 6, wherein the mobile device 6 activates a camera therein for capturing an image of a QR code. An image capturing screen 100 such as the one shown in FIG. 6 will pop up on the mobile device 6. The image capturing screen 100 includes a window 102 wherein a captured image is preferably located. The App will process the captured image of the QR code to obtain the unique code associated with the showroom and/or the cars at the showroom. The mobile device 6 then sends the unique code to the server 4.

The method 70 next proceeds to a REQUEST USER PARTICULARS step 110 in the server 4, wherein the server 4 validates the unique code. If the unique code is successfully validated, the server 4 sends a request to the mobile device 6 to request the particulars of the potential buyer. The mobile device 6 will display a profile screen 112 as shown in FIG. 7. The profile screen 112 includes fields for the potential buyer to enter his or her name, mobile number and email address. The profile screen 112 also includes a link to terms and conditions that the potential buyer will have to agree to before being allowed to view the cars at the showroom. The profile screen 112 also includes a call-to-action button “Next” which the potential buyer can tab on when he or she is ready to proceed to a next step.

The method 70 next proceeds to a PROVIDE PARTICULARS step 114 at the mobile device 6, wherein the mobile device 6 sends the potential buyer's particulars to the server 4. The method 70 next proceeds to a CREATE TICKET step 116 at the server 4, wherein the server 4 creates a ticket for the potential buyer. This ticket includes a status field that is set to WAITING at this time. The server 4 will send queue information to the mobile device 6 at regular intervals to let the potential buyer know where he or she is in the queue to view the cars at the showroom. The method 70 next moves to a DISPLAY QUEUE STATUS step 118 at the mobile device 6 and an UPDATE QUEUE STATUS step 120 in the server 4, wherein the mobile device 6 displays queue information that it receives from the server 4. In the DISPLAY QUEUE STATUS step 118 and the UPDATE QUEUE STATUS step 120, a real-time connection is established between the mobile device 6 and the server 4. The mobile device 6 establishes this real-time connection by using the WebSocket API. The WebSocket API functions by opening a two-way interactive communication session between the mobile device 6 and the server 4. The WebSocket API allows the mobile device 6 to send messages to the server 4 and to receive event-driven responses without having to poll the server 4 for a reply. Websocket is the primary interface for connecting to a Websocket server to establish a connection and then for sending and receiving data on that connection. An Websocket object provides the API for creating and managing the Websocket connection to the server 4, as well as for sending and receiving data on the connection. “CloseEvent” is the event sent by the WebSocket object when the connection closes, and “MessageEvent” is the event sent by the WebSocket object when a message is received from the server. The Websocket API can thus be used to update the potential buyer's queue number accordingly. The socket connection is authorized with an Auth Url and the potential buyer's user ID. The socket connection will be closed when the potential buyer quits the App or leaves the queue page.

In the UPDATE QUEUE STATUS step 120 at the server 4, the server 4 creates a channel specific to the potential buyer's user ID and binds the potential buyer for queue related events. If a potential buyer leaves the queue or ends the session, the server 4 will notify all the other potential buyers in the queue via the socket connection. If the potential buyer is still in the queue, the App will show the updated queue number and estimated waiting time. After the socket connection is successfully established, the App will subscribe to the channel that is specific to the potential buyer's user ID and bind the potential buyer for queue related events.

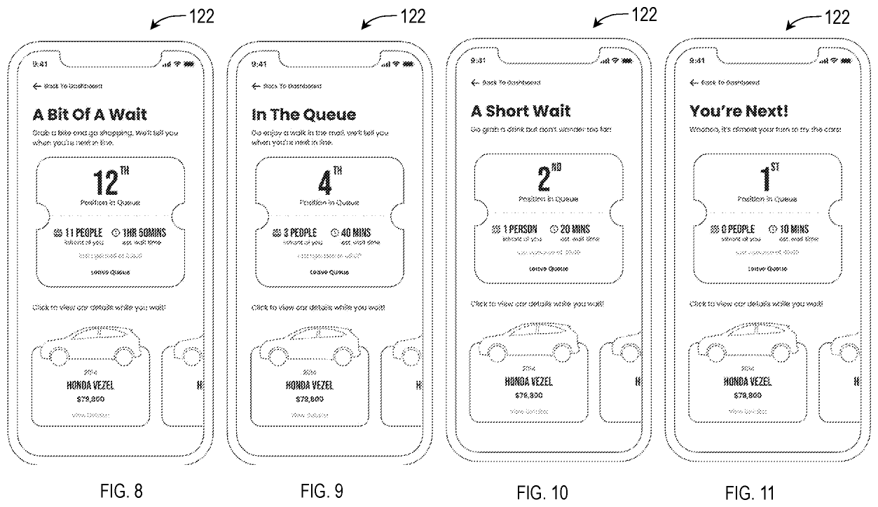

Each of FIGS. 8-11 shows a queue screen 122 that includes the potential buyer's position in the queue and timing information indicating approximately how long more the potential buyer will have to wait for his or her turn to view the cars. As each potential buyer is given a predetermined period to view a car, the estimated waiting time will be given by the predetermined period multiplied by the number of potential buyers ahead of the potential buyer in the queue. FIG. 11 shows the queue screen 122 when the buyer becomes the first in the queue.

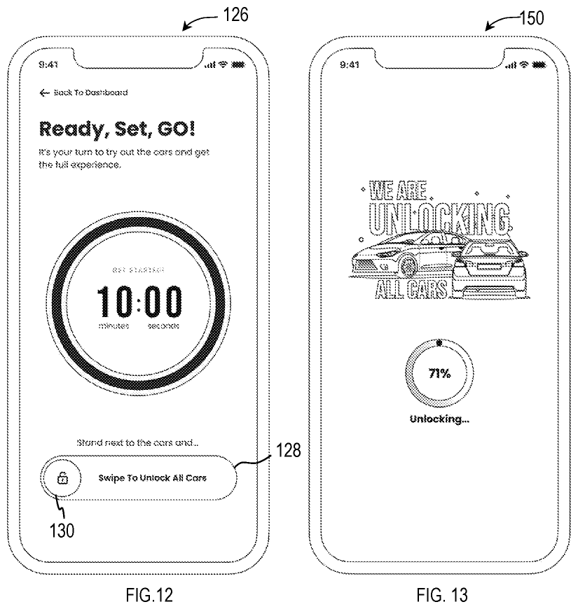

When it is the turn for the potential buyer to view the cars, the method 70 next proceeds to a SWIPE TO UNLOCK step 124 at the mobile device 6, wherein the App automatically takes the potential buyer to the beginning of a viewing session where he or she can unlock the cars and start viewing and/or testing the cars. The App displays a car-unlock screen 126 on the mobile device 6 as shown in FIG. 12. The information on the car-unlock screen 126 includes the amount of time the potential buyer has for viewing the cars. In this embodiment, the potential buyer is given 10 minutes to view the car. However, the allocated time may be longer if the user is also allowed to test drive the cars. The car-unlock screen 126 also includes a call-to-action “Swipe to Unlock All Cars” slider bar 128.

When the potential buyer swipes an unlock icon 130 across the length of the slider bar 128, the mobile device 6 will send information to the server 4 indicating that the potential buyer is ready to view the cars. The method 70 next proceeds to INFORM USER OF TIME LEFT step 132 at the server 4, wherein the server 4 will communicate with the Twilio system 8 to instruct it to send an SMS message to a key fob actuator 136 in the car. The Twilio system uses Amazon Web Services to host telephone infrastructure and provide connectivity between HTTP and the public switched telephone network (PSTN) through its APIs. The method 70 proceeds to a SEND UNLOCK SMS step 134 at the Twilio system 8, wherein the Twilio system 8 uses Twilio's Verify API that requires two unique account SID and Auth tokens to remotely send the SMS message to one or more key fob actuators 136. Other similar systems that can send wireless commands to the key fob actuators 136 may also be used. Each key fob actuator 136 may be located in a car or in the proximity of the car. The alphanumeric text in the SMS message may include for example “Your unlocking verification code is: 0001”. The SMS message may further include a unique PIN for authentication purposes. The method 70 further proceeds to an ACTUATE KEY FOB step 140 at the key fob actuator 136, wherein the key fob actuator 136 receives the SMS message, verifies its authenticity, and actuates an unlock button of a key fob (not shown) of a car. The key fob sends a wireless signal to the electronics of the car to unlock the doors of the car. All key fob actuators of cars at the showroom may be activated by the single SMS message. In other embodiments, each key fob actuator can be activated by a key fob actuator specific SMS message so that the cars may be individually unlocked. Any type of key fob actuator 136 may be used. These include but are not limited to those disclosed in U.S. Pat. No. 9,576,414, Tieman, entitled “Remote Control Button Actuator with Removable Tray”, US Patent Application No. 2009/00108989A1, Sinclair, entitled “Personal Access Arrangement for a Vehicle and PCT Application No. PCT/SG2021/050463, Chen, entitled “A Remote-Control Actuator”.

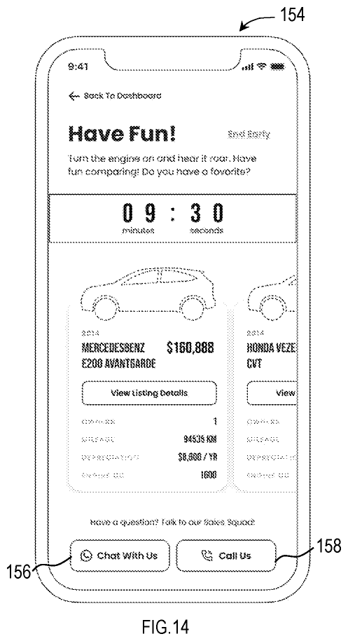

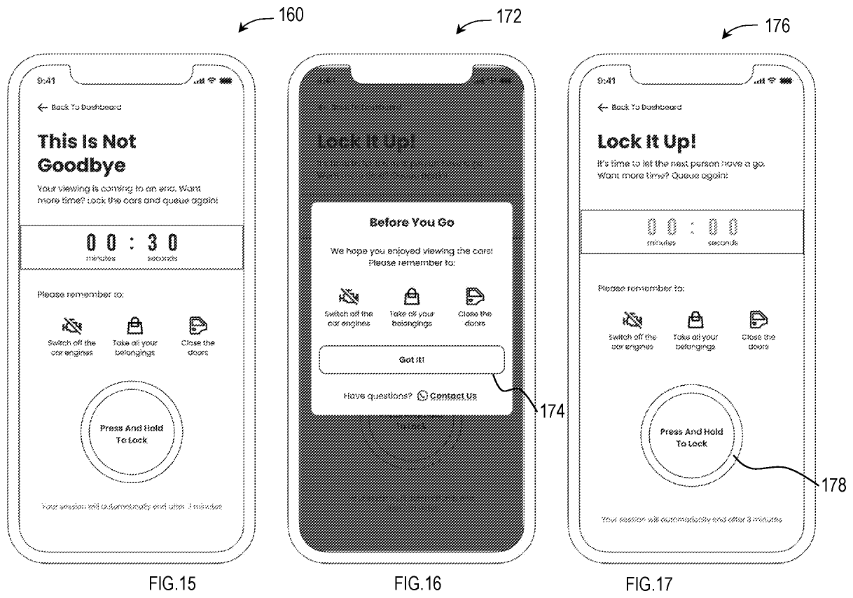

In the INFORM USER OF TIME LEFT step 132 at the server 4, the server 4 also sends status information to the mobile device 6 to indicate the status of the cars unlocking process. An unlock status screen 150 such as the one shown in FIG. 13 will be displayed on the mobile device. The unlock status screen 150 shows that the unlocking process is 71% completed. The key fob actuator may inform the server 4 when unlocking is completed. In this step 132, the server 4 also updates the status of the ticket to VIEWING CAR. When the unlocking process is completed, the server 4 sends information related to time left for the potential buyer to view the cars to the mobile device 6. The method 70 next proceeds to a DISPLAY TIME LEFT step 152 at the mobile device 6, wherein the time left is displayed on the mobile device 6 in a time left screen 154 as shown in FIG. 14. This time left screen 152 also includes cars available at the showroom the mobile device 6 is at. The cars are displayed in a row with a last car partially displayed to indicate to the user that there are more cars than what is shown on the screen available at the showroom. Unlike the catalog screens 82, 96 shown in FIGS. 3 and 5, cars are displayed with more information in this time left screen 152. The information includes but is not limited to price, number of owners, mileage, depreciation, engine capacity, etc. The time left screen 154 also includes a call-to-action “View Listing Details” button for the potential buyer to view further details of each car. The time left screen 154 further includes a call-to-action “Chat With Us” button 156 and a “Call Us” button 158 to allow the potential buyer to exchange text messages and speak with an online salesperson respectively. The mobile device 6 maintains and updates the amount of time. FIG. 15 shows a time left screen 160 showing the time left for the potential buyer to view the cars is thirty seconds. Instead of showing cars available for viewing at the showroom, this time left screen 160 displays instructions for the potential buyer instead. These instructions include informing the potential buyer to switch off the car engines, to take all his or her belongings and to close the car doors. The time left screen 160 also includes a call-to-action “Press And Hold To Lock” button that the potential buyer can tap on to lock the doors of the cars.

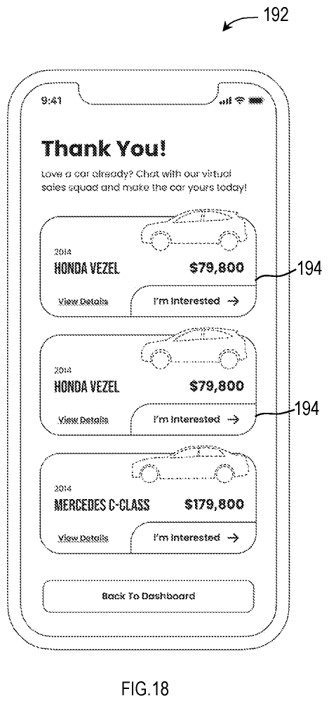

When the allotted time for the potential buyer has run out, the method 70 proceeds to an INFORM USER TIME IS UP step 170 at the server 4, wherein the server 4 sends information to the mobile device 6 for the mobile device 6 to display a lock-car screen 172 as shown in FIG. 16. This lock-car screen 172 reminds the potential buyer once again to switch off the car engines, to take all his or her belongings and to close the car doors. The potential buyer can acknowledge receipt of these instructions by tapping on a call-to-action “Got It!” button 174 on the lock-car screen 172. At this point, the lock car screen 172 transitions to the time left screen 176 as shown in FIG. 17 where the time left is shown to be zero. The time left screen 176 includes a call-to-action “Press And Hold To Lock” button 178. When the potential buyer tabs on this button 178, the method 70 proceeds to a LOCK CAR step 180 at the mobile device 6, wherein the mobile device 6 sends an instruction to the server 4 to lock the doors of the cars. The method 70 next proceeds to an END step 182 at the server 4, wherein the server 4 instructs the Twilio system 8 to send another SMS message to the key fob actuators 136 to lock the doors of the cars. The method 70 proceeds to a SEND LOCK SMS step 184 at the Twilio system 8, wherein the Twilio system 8 remotely sends the SMS message to the key fob actuators 136. The method 70 proceeds next to the ACTUATE KEY FOB step 186, wherein each key fob actuator 136 receives the SMS message, verifies it and actuates the lock button of the respective key fob stored therein to lock the car doors. The alphanumeric text in the SMS message may include for example “Your locking verification code is: 0002”. In the END step 182, the server 4 also sends information to the mobile device 6 to allow it to display the cars that the potential buyer has just viewed in a DISPLAYED CARS VIEWED step 190 at the mobile device 6. For each car displayed in a cars viewed screen 192 as shown in FIG. 18, there is a call-to-action “I'm Interested” button 194. When the potential buyer taps on such a “I'm interested” button, he or she will be put in touch with an online assistant who can provide more information of the car or process the purchase if the potential buyer decides to buy the car. The server 4 also updates the status of the ticket to INTERESTED to indicate that the potential buyer showed further interest after viewing the cars. The ticket may also include an ID of that particular car in which the potential buyer showed interest in.

A method of dealing in cars is described next. The method includes a dealer locating cars at different geographic locations and the dealer maintaining a database 16 having a record for each of the cars. The record includes a geographic location of the car. The method further includes the dealer retrieving one or more records from the database 16, the dealer providing a potential buyer with the one or more retrieved records, the dealer receiving from the potential buyer information indicating interest in viewing one or more cars corresponding to the one or more retrieved records, and the dealer sending an instruction remotely to an unlocking device 136 located either within or in the proximity of the one or more cars to automatically unlock the one or more cars.

The method may further include the potential buyer providing the dealer with a location of the potential buyer, and in such a case the dealer retrieving at least one record from the database includes the dealer retrieving one or more records from the database based on the location of the potential buyer. In some embodiments of the method, the dealer retrieving one or more records from the database based on the location of the potential buyer includes the dealer retrieving one or more records from the database having a geographic location closest to the location of the potential buyer.

Advantageously, with the car dealership system 2 described above, cars for sale can be parked at any location so long as there is ample parking space at that location, and potential buyers can then visit that location as a showroom. There could thus be a showroom at every shopping mall parking lot, car park next to a train station, etc. making access to a showroom convenient to a potential buyer. The system 2 also does away with the need for salespersons to be physically present at each location to lock and unlock the cars. There is also a greater degree of independence and freedom granted to a potential buyer, who prefers to experience the car by themselves.

Although the present invention is described as implemented in the above-described embodiments, it is not to be construed to be limited as such. For example, although it is described that the potential buyer launches the App to run the App, this is not to be construed to be limited as such. The potential customer may be able to rely on the Deep Linking technology to simply scan the QR code on a car using any other apps to have the App automatically launched. If the App has not been downloaded on the mobile device, the QR code will take the potential customer to a suitable application store where he or she can download the App according to the mobile device's operating system platform.

As another example, it is described that the potential buyer is allowed to view all cars at a particular showroom. It should however be recognized that the server 4 can unlock each car individually at the showroom. Each car may be unlocked with a dedicated SMS message for that car.

As yet another example, it is described that a key fob actuator is used as a car doors locking/unlocking device. However, other means for locking and unlocking the car can also be used. These other means include but are not limited to modifications to the electronics in the car to directly actuate solenoids for locking and unlocking the car doors.

As yet a further example, it is described that system is used for a used car dealership. However, the system may also be used in a dealership that deals with all kinds of new and used cars, trucks, vans, etc. The system may also be used for a car rental business.

It should be further appreciated by the person skilled in the art that one or more of the above modifications or improvements, not being mutually exclusive, may be further combined to form yet further embodiments of the present invention.

1. A car dealership system comprising:
a database configurable to maintain a record for each of a plurality of cars for sale, the plurality of cars being located at different geographical sites and each record including a geographic location of a corresponding one of the plurality of cars; and
a server operable to:
retrieve at least one record from the database;
provide a user device with the at least one retrieved record;
receive information from the user device indicating interest in viewing at least one car corresponding to the at least one retrieved record; and
send an instruction remotely to an unlocking device located one of within and in the proximity of the at least one car to automatically unlock the at least one car.

2. The car dealership system according to claim 1, wherein the user device comprises a mobile device, and wherein the server is further operable to receive a location of the mobile device and wherein retrieving at least one record from the database comprises retrieving at least one record from the database based on the location of the mobile device.

3. The car dealership system according to claim 2, wherein retrieving at least one record from the database based on the location of the mobile device comprises retrieving at least one record from the database having a geographic location closest to the location of the mobile device.

4. The car dealership system according to claim 1, wherein the unlocking device is located within the at least one car and configured to actuate an unlock key of a key fob of the at least one car.

5. The car dealership system according to claim 4, wherein the instruction to automatically unlock the at least one car comprises a short messaging service (SMS) message sent to the unlocking device.

6. The car dealership system according to claim 1, wherein receiving information from the user device comprises receiving information obtainable from a label attached to the car using the user device.

7. The car dealership system according to claim 6, wherein the label comprises a QR code.

8. The car dealership system according to claim 1, wherein the instruction unlocks all cars at the same geographic location as the at least one car.

9. The car dealership system according to claim 1, wherein the server is further operable to receive information of a user using the user device after receiving information from the user device of at least one car corresponding to the at least retrieved record.

10. The car dealership system according to claim 9, wherein the server is further operable to send to the user device the user's queue position before the user's turn to access the at least one car after receiving the user's information.

11. The car dealership system according to claim 10, wherein the server is further operable to receive from the user device information to unlock the at least one car prior to the server sending the instruction to the unlocking device.

12. The car dealership system according to claim 1, wherein the server is further operable to send to the user device information relating to an amount of time left for the user to view the at least one car.

13. The car dealership system according to claim 12, wherein the server is further operable to send to the user device information indicating time for the user to view the at least one car is up and that the user should lock the at least one car.

14. The car dealership system according to claim 13, wherein the server is further operable to send an instruction to a locking device to automatically lock the at least one car.

15. The car dealership system according to claim 1, further comprising the mobile device.

16. A method of dealing in cars, the method comprising:
a dealer locating cars at different geographic locations;
the dealer maintaining a database having a record for each of the cars, the record including a geographic location of the car;
the dealer retrieving at least one record from the database;
the dealer providing a potential buyer with the at least one retrieved record;
the dealer receiving from the potential buyer information indicating interest in viewing at least one car corresponding to the at least one retrieved record; and
the dealer sending an instruction remotely to an unlocking device located one of within and in the proximity of the at least one car to automatically unlock the at least one car.

17. The method according to claim 16, further including the potential buyer providing the dealer with a location of the potential buyer, and wherein the dealer retrieving at least one record from the database comprises the dealer retrieving at least one record from the database based on the location of the potential buyer.

18. The method according to claim 17, wherein the dealer retrieving at least one record from the database based on the location of the potential buyer comprises the dealer retrieving at least one record from the database having a geographic location closest to the location of the potential buyer.
